(19) United States
(12) Patent Application Publication
(10) Pub. No.: US 2007/0238437 A1
(43) Pub. Date: Oct. 11, 2007

(54) Delayed host wakeup for wireless communications device

(75) Inventor: Mikko Jaakkola, Lempaala (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/402,285

(22) Filed: Apr. 10, 2006

(51) Int. Cl. H04B 1/16; H04B 1/38

(52) U.S. Cl. 455/343.1; 455/574

(57) ABSTRACT

A new and unique method or apparatus for power savings in a node, point, terminal or device in a wireless local area network (WLAN), or other suitable network, featuring one or more steps for delaying forwarding one or more data packets from a WLAN chipset to a host processor based on information received by the WLAN chipset about whether the host processor is in a sleep state. The host processor has a clock request pin to indicate when it is in the sleep state. The WLAN chipset has a pin that is connected to a sleep state signal of the host processor so that the WLAN chipset knows when it can wake up the host processor or not. The WLAN chipset has an internal threshold timer to fulfil latency requirements for delivering packets to the host processor.

### BACKGROUND OF THE INVENTION

1. Field of Invention

The present invention relates to WLAN technology and its system architecture as well as host processor power-management policies in mobile application processors, including that set forth in IEEE 802.11. More particularly, the present invention relates to power savings in the WLAN environment, and providing a method and system for reducing power consumption in WLAN host processor by providing means to synchronizing host wake-up events to host processor power-state by delaying forwarding packets received via a WLAN interface until host processor is in active state or waiting r a certain amount of time to enhance power savings in the host processor.

2. Description of Related Art

FIG. 1 shows, by way of example, typical parts of an IEEE 802.11 WLAN system, which is known in the art and provides for communications between communications equipment such as mobile and secondary devices including personal digital assistants (PDAs), laptops and printers, etc. The WLAN system may be connected to a wired LAN system that allows wireless devices to access information and files on a file server or other suitable device or connecting to the Internet.

The devices can communicate directly with each other in the absence of a base station in a so-called “ad-hoc” network, or they can communicate through a base station, called an access point (AP) in IEEE 802.11 terminology, with distributed services through the AP using local distributed services (DS) or wide area extended services, as shown. In a WLAN system, end user access devices are known as stations (STAs), which are transceivers (transmitters/receivers) that convert radio signals into digital signals that can be routed to and from communications device and connect the communications equipment to access points (APs) that receive and distribute data packets to other devices and/or networks. The STAs may take various forms ranging from wireless network interface card (NIC) adapters coupled to devices to integrated radio modules that are part of the devices, as well as an external adapter (USB), a PCMCIA card or a USB Dongle (self contained), which are all known in the art.

FIGS. 2a and 2b show diagrams of the Universal Mobile Telecommunications System (UMTS) packet network architecture, which is also known in the art. In FIG. 2a, the UMTS packet network architecture includes the major architectural elements of user equipment (UE), UMTS Terrestrial Radio Access Network (UTRAN), and core network (CN). The UE is interfaced to the UTRAN over a radio (Uu) interface, while the UTRAN interfaces to the core network (CN) over a (wired) Iu interface. FIG. 2b shows some further details of the architecture, particularly the UTRAN, which includes multiple Radio Network Subsystems (RNSs), each of which contains at least one Radio Network Controller (RNC). In operation, each RNC may be connected to multiple Node Bs which are the UMTS counterparts to GSM base stations. Each Node B may be in radio contact with multiple UEs via the radio interface (Uu) shown in FIG. 2a. A given UE may be in radio contact with multiple Node Bs even if one or more of the Node Bs are connected to different RNCs. For instance, a UE1 in FIG. 2b may be in radio contact with Node B2 of RNS1 and Node B3 of RNS2 where Node B2 and Node B3 are neighboring Node Bs. The RNCs of different RNSs may be connected by an Iur interface which allows mobile UEs to stay in contact with both RNCs while traversing from a cell belonging to a Node B of one RNC to a cell belonging to a Node B of another RNC. The convergence of the IEEE 802.11 WLAN system in FIG. 1 and the (UMTS) packet network architecture in FIGS. 2a and 2b has resulted in STAs taking the form of UEs, such as mobile phones or mobile terminals. The interworking of the WLAN (IEEE 802.11) shown in FIG. 1 with such other technologies (e.g. 3GPP, 3GPP2 or 802.16) such as that shown in FIGS. 2a and 2b is being defined at present in protocol specifications for 3GPP and 3GPP2.

Currently, when a packet arrives to a WLAN chipset it is passed straight to a host processor and thus possibly waking up the host processor from a deep-sleep. There is no known prior art where WLAN HW is aware of the host processor state and using that information to adjust its own behaviour. While filtering of common packets (i.e. ARP request) is done by some known vendors, theses techniques are restricted to a very narrow context (i.e. the ARP packets).

Some power saving techniques in communications devices include the following: United States publication no. 2005/0181840 discloses power management in communication devices where actual power savings is achieved by using a power savings mode in a communications device may be increased by analyzing the effects of the power savings mode on delays and using the analysis on which to base a decision as to whether or not to enter the power savings mode. In comparison, United States publication no. 2004/0264396 discloses a method, apparatus and system for power saving in a wireless LAN, by buffering data packets until a transmission or wake-up trigger occurs, at which time all buffered data packets may be transmitted. The buffering can be maintained until a scheduled transmission period begins, or alternatively until the buffer is full. In effect, the aforementioned known techniques merely provide for the basic decision whether a device should enter into a power saving mode.

In view of this, there is a need in the art for a method, system or technique in which a wake signal is delayed for enabling the host processor to handle several data packets at a single activity period.

### SUMMARY OF THE INVENTION

The present invention provides a new and unique method and apparatus for power savings in a node, point, terminal or device in a wireless local area network (WLAN), or other suitable network, featuring one or more steps or elements for delaying forwarding one or more data packets from a WLAN chipset to a host processor based on information received by the WLAN chipset about whether the host processor is in a sleep state.

The basic idea of the present invention is for the WLAN chipset in the node, point, mobile terminal or device to obtain information regarding the current state of the host processor and buffer received packets until a certain threshold time and/or packet size and/or packet is received and/or host processors is detected to move into active mode.

In operation, the WLAN chipset buffers received data packets if one or more of the following rules apply:

1) The host processor is in sleep state;

2) An internal timer indicated that there is still time left for the internal timer for ensuring possible latency requirements for communication;

3) The internal buffer memory is not full; or

4) A received packet is not seen as being a very important packet, which would suffer from the extra latency.

The present invention is implemented using signaling between the host processor and the WLAN modem so that the host processor can signal its change of states to the WLAN modem and the WLAN modem can operate or respond accordingly.

In effect, the present invention provides a basic technique to reduce power-consumption of an idle WLAN enabled device that is connected to a network by deferring packet delivery and having the knowledge of the host processor state.

The scope of the invention may also include a node, point, terminal or device in a wireless local area network (WLAN) or other suitable network. The node, point, terminal or device may include a station (STA) or other suitable network node, point, terminal or device in the WLAN. Moreover, the scope of the invention may also include a WLAN chipset for such a node, point, terminal or device in such a wireless local area network (WLAN) or other suitable network, as well as a computer program product with a program code, which program code is stored on a machine readable carrier, for carrying out the steps of the method according to the present invention. The method may also feature implementing the step of the method via a computer program running in a processor, controller or other suitable module in one or more network nodes, points, terminals or elements in the wireless LAN network.

In one embodiment, the present invention provides a method for enhancing power savings in a WLAN terminal, having the following steps: receiving one or more data packets from a wireless communications network; obtaining information regarding operational state of a host processor; and if the host processor is in sleep state, delaying forwarding of the one or more data packets to the host processor until one or more threshold criteria is met.

### BRIEF DESCRIPTION OF THE DRAWING

The drawing includes the following Figures, which are not necessarily drawn to scale:

FIG. 1 shows typical parts of an IEEE 802.11 WLAN system, which is known in the art.

FIGS. 2a and 2b show diagrams of the Universal Mobile Telecommunications System (UMTS) packet network architecture, which is also known in the art.

FIG. 3 shows a WLAN enabled device according to the present invention.

FIG. 4 shows a WLAN chip that forms part of the WLAN enabled device shown in FIG. 3 according to the present invention.

FIG. 5 shows a flowchart of the basic steps of the method according to the present invention.

FIG. 6 shows a diagram of a simplified WLAN device system according to the present invention.

FIG. 7 shows a diagram of a modified WLAN device system according to the present invention.

FIG. 8 shows a basic algorithm of WLAN HW according to the present invention.

FIG. 9 shows a diagram of a host wake-up pattern.

### BEST MODE OF THE INVENTION

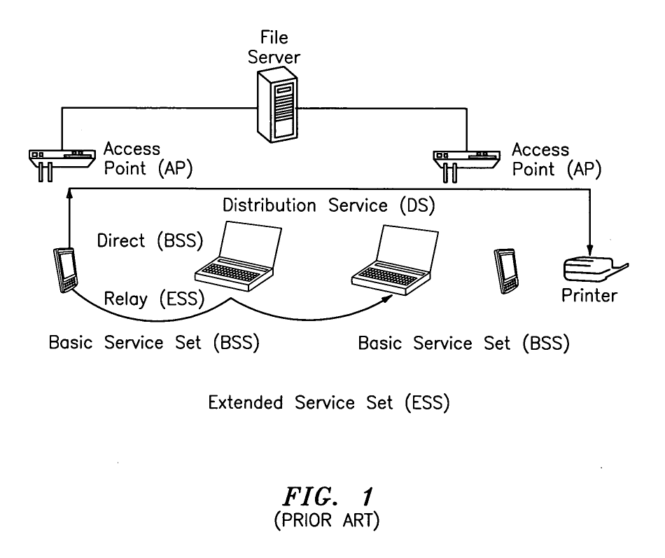

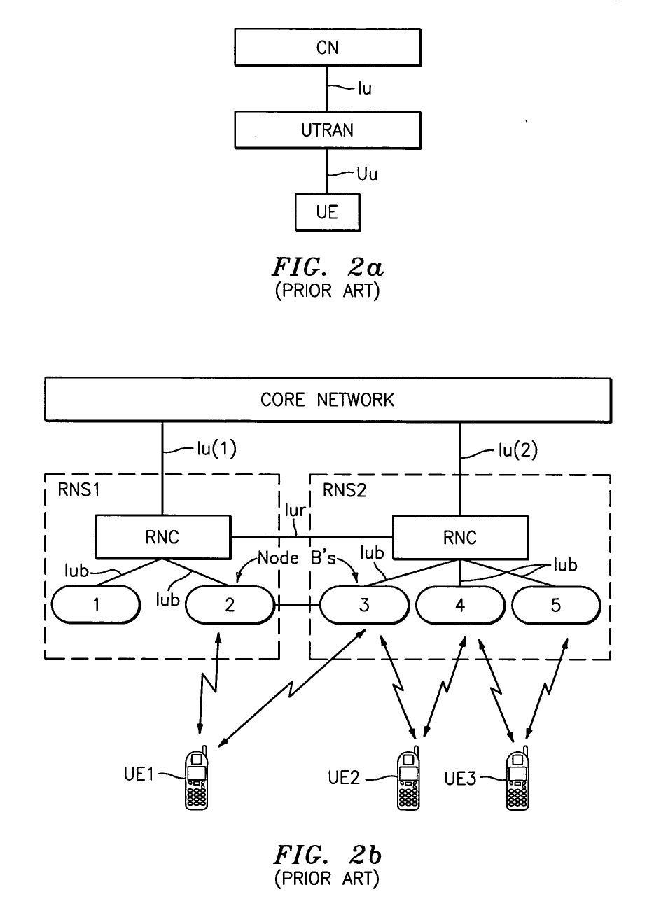

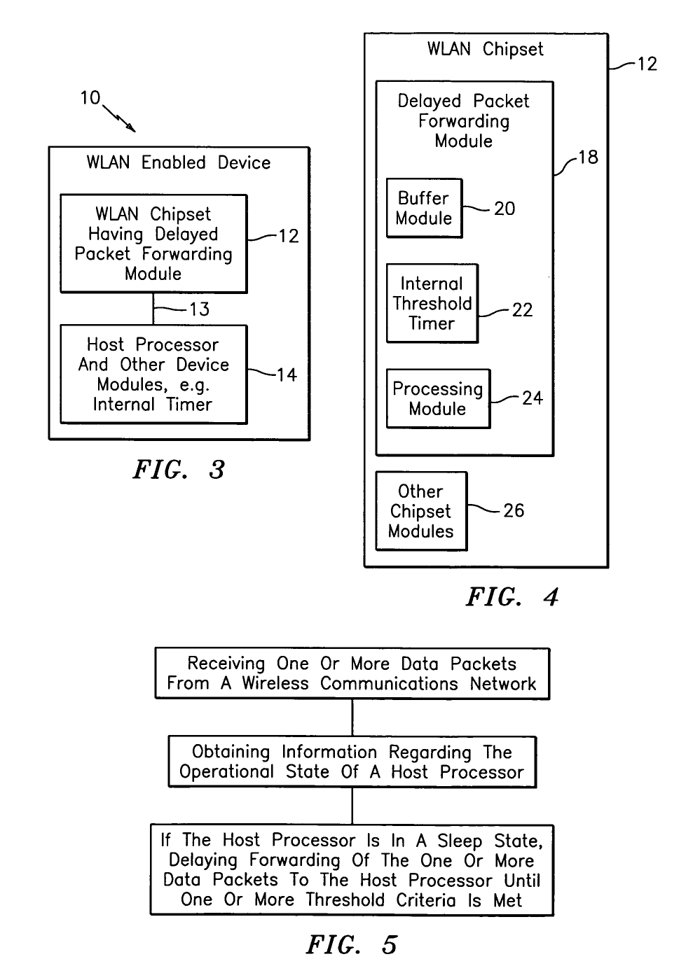

FIG. 3 shows a node, point, terminal or device in the form of a WLAN enabled device generally indicated 10 according to the present invention for a wireless local area network (WLAN) or other suitable network such as that shown in FIGS. 1, 2a and 2b. The WLAN enabled device 10 has a WLAN chipset 12 having a delayed packet forwarding module 18 (see FIG. 4) for delaying forwarding one or more data packets from the WLAN chipset 12 to a host processor 14 based on information received by the WLAN chipset 12 about whether the host processor 14 is in a sleep state. The present invention is implemented using an exchange of signaling between the WLAN chipset 12 and the host processor 14, for example, along line 13, so that the host processor 14 can signal its change of states to the WLAN chipset 12, and the WLAN chipset 12 can operate or respond accordingly, consistent with that shown and described herein. The WLAN enabled device 10 may take the form of a station (STA), or other suitable node, point, terminal or device either now known or later developed in the future for operating in such a wireless local area network (WLAN) or other suitable network such as that shown in FIGS. 1, 2a and 2b. In addition, the one or more data packets may be received by the WLAN enabled device 10 from a network or other device (not shown). The scope of the invention is not intended to be limited to the type or kind of packets being received by the WLAN enabled device 10, or from where the packets are received.

FIG. 4 shows, by way of example, the WLAN chipset 12 in further detail, where the delayed packet forwarding module 18 includes a buffer module 20, an internal threshold time 22, and a processing module 24. In operation, the processing module cooperates with the buffer module 20 and the internal threshold time 22 consistent with that shown and described herein for delaying the forwarding of the one or more data packets from the WLAN chipset 12 to the host processor 14 based on information received by the WLAN chipset 12 about whether the host processor 14 is in the sleep state. The WLAN chipset 12 may also include other chipset modules that do not necessarily form part of the underlying invention and are not described in detail herein, including a baseband module, a MAC module, a host interface module. Although the present invention is described in the form of a stand alone module for the purpose of describing the same, the scope of the invention is invention is intended to include the functionality of the delayed packet forwarding module 18 being implemented in whole or in part by one or more of these other chipset modules 26. In other words, the scope of the invention is not intended to be limited to where the functionality of the present invention is implemented in the WLAN chipset 12.

In particular, the overall technique according to the present invention may be implemented, by way of example, as follows:

The host processor 14 may have a clock request pin to indicate when it is in the deep-sleep (i.e. the main clock is not running).

Similarly, the WLAN chipset 12 may have a corresponding pin that is connected to and receives a deep-sleep signal from the host processor 14 so that the WLAN chipset 12 knows when it can wake up the host processor 14 or not. The clock request pin of the host processor 14 and the corresponding pin of the WLAN chipset 12 may form part of the coupling of these elements by the line 13. The WLAN chipset 12 may also have an internal threshold timer, such as element 22 in FIG. 4, that is need for the WLAN chipset software (SW) to fulfil some kind of latency requirements for delivering packets to the host processor 14.

In operation, the present invention would operate as follows:

If the WLAN chipset 12 detects via, for example, a wired connector (e.g. the line 13) that the host processor 14 is in a deep-sleep, then the WLAN chipset 12 will not deliver any packets to the host processor 14 until one of the following conditions is met:

a) the receive RX delay timer, such as element 22 has expired,

b) the buffer module 20 of the WLAN chipset 12 starts to run out of memory or its buffering threshold, or

c) the host processor 14 happens to wake-up before the RX delay timer, such as 22, has been expired.

The WLAN host processor may also have provisions to allow some type of API for controlling the time-out values and an ability to turn the feature off if needed.

In effect, the basic idea is to delay a packet received via the WLAN for a certain amount of time or until the host processor is woken up as in most cases (pretty much in all cases) packets sent in an idle mode don't have small latency requirements.

The following are two examples of the basic implementation:

### EXAMPLE 1

### Chipset Time-Out

Time 0 ms: The WLAN chipset 12 may receive a broadcast packet from the network or other device (not shown), but it also detects that the host processor 14 is in a deep-sleep so it decides not to pass the packet up just yet.

Time 300 ms: The WLAN chipset receives another broadcast packet, but as the host processor 14 is still in the deep sleep it decides to buffer this packet as well.

Time 800 ms: The WLAN chipset internal timer 22 has been fired and it decides to wake up the host processor 14 by raising an interrupt pin and thus it gets to deliver the packet to the host processor 14.

### EXAMPLE 2

### Host Processor Awakens

Time 0 ms: The WLAN chipset 12 receives a broadcast packet from the network or other device (not shown) but it also detects that the host processor 14 is in a deep-sleep so it decides not to pass the packet up just yet.

Time 200 ms: The host processor 14 is woken up by some internal timer, such as that shown in FIG. 3.

Time 200.001 ms: The WLAN chipset 12 has detected that the host processor 14 has woken up (e.g. via the signal exchange along line 13) and it raises a receive (RX) interrupt and thus delivers the packet to the host processor 14.

### Implementation of the Functionality of Module 24

By way of example, and consistent with that described herein, the functionality of the modules 24 may be implemented using hardware, software, firmware, or a combination thereof, although the scope of the invention is not intended to be limited to any particular embodiment thereof. In a typical software implementation, the module 12 and 22 would be one or more microprocessor-based architectures having a microprocessor, a random access memory (RAM), a read only memory (ROM), input/output devices and control, data and address buses connecting the same. A person skilled in the art would be able to program such a microprocessor-based implementation to perform the functionality described herein without undue experimentation. The scope of the invention is not intended to be limited to any particular implementation using technology now known or later developed in the future. Moreover, the scope of the invention is intended to include the module 24 being a stand alone module, as shown, or in the combination with other circuitry for implementing another module.

The other chipset modules 26 may also include other modules, circuits, devices that do not form part of the underlying invention per se. The functionality of the other modules, circuits, device that do not form part of the underlying invention are known in the art and are not described in detail herein.

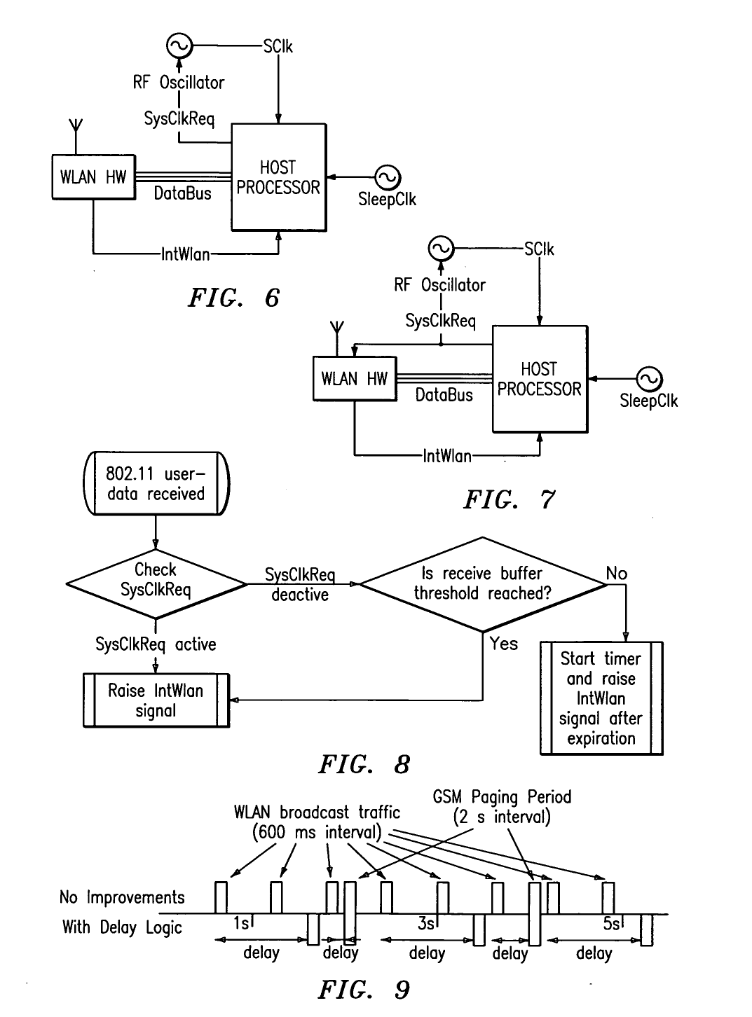

### FIGS. 6-7: Simplified Examples of WLAN Systems

FIG. 6 shows a simplified WLAN device system. In operation, when the host processor is in a sleep mode only a sleep clock (SleepClk) is on so that the host processor can wake itself up when external peripherals want to wake system up. For example, when the WLAN HW wants to wake the system up, it first raises the interrupt line (IntWlan) line, which causes the host processor to enable the system clock request (SysClkReq) to get the main processor up running once the RF oscillator is stabilized. Once the host processor is fully ready, it processes the interrupt and pulls data from the WLAN HW. After processing, the system will disable the clock request signal and enter back into a deep-sleep.

Alternatively, FIG. 7 shows a modified system that is similar to the system shown in FIG. 6, with an exception that the SysClkReq is connected to WLAN HW via general purpose I/O pin so that it can detect the state of the host processor's main clock and use the info to adjust its behaviour.

### FIG. 8: Basic Algorithm of WLAN HW

FIG. 8 shows a diagram of the basic algorithm of the WLAN HW. The algorithm is run locally in WLAN MAC processor and it starts from the receive even if the system is not woken up in a certain time period, the WLAN HW will anyway raise the interrupt line to wake up the host processor. Also sudden bursts of data can cause the system to wake up sooner than normally to ensure that the receive buffers don't run out and also burst of packets destined to the station is a good hint that some host level activity is needed anyway.

### FIG. 9: The Host Wake-Up Pattern

The present invention allows significant power-savings in a mobile device using WLAN by providing a technique for the WLAN subsystem to optimize how it wakes up a sleeping host processor or system. The technique is particularly aimed at reducing the penalty that processing the broadcast/multicast and keep-alive traffic causes in the host processor by forcing the host processor to wake up from a deep-sleep. The optimization is carried out by delaying the wake-up until the host processor needs to do so for some other event and thus allowing synchronization of the two different events into single wake-up and that way allowing the host processor to have no penalty of stochastic and keep-alive receive events.

FIG. 9 provides an overview how the algorithm according to the present invention works from a system wake-up perspective. As shown, the wake-up pattern on top of the timeline describes the behaviour without any enhancements in the situation where WLAN subsystem receives packets from the network every 600 ms and GSM subsystem wakes up the system for every paging request in every 2 seconds. By combining, multiple receives into one wake-up by having 1 second delay period and leveraging the forced wake-up by GSM paging period, the host processor is able to reduce the amount of wake-up from 10 to 5.

### The WLAN Chipset

The present invention may also take the form of the WLAN chipset 12 for a node, point, terminal or device in a wireless local area network (WLAN) or other suitable network, that may include a number of integrated circuits designed to perform one or more related functions. For example, one chipset may provide the basic functions of a modem while another provides the CPU functions for a computer. Newer chipsets generally include functions provided by two or more older chipsets. In some cases, older chipsets that required two or more physical chips can be replaced with a chipset on one chip. The term “chipset” is also intended to include the core functionality of a motherboard in such a node, point, terminal or device.

### Advantages

One advantage of the present invention is that it allows the overall system of the WLAN enable device 10 to save power by synchronizing the wake-up of the host processor with the rest of the overall system. By way of example, the power-saving impact may be quantified as following:

In the basic mobile application processor platform, the host processor such as 14 consumes around 40-80 mA of current when being not idled. When it goes into a deep-sleep, the current consumption is minimal (say, for example, about 0.2 mA).

When the host processor wakes up to do something, it typically goes back to sleep in around 50-200 ms. So one event every second would cause between 2-16 mA of base current consumption. If the WLAN network sends broadcast/multicast data in enterprise (or home environment having UPnP) environment (PCs to a lot of this) twice in every second and on top of this various applications are receiving keep-alive messages, then one could assume that the host processor gets woken up around every 300-400 ms, resulting in about 6-48 mA of base current consumption.

Being able to wake up only once a second for all the received packets would drop the power-consumption down to about 2-16 mA and if one assumes that that something else wakes up the system every few seconds, then the penalty of WLAN power-consumption can be even less as the WLAN packets can be processed when the host processor is up for some other activities. The average current (assuming other background activity) would probably be around 6 mA with the mentioned network traffic. A saving of about 14 mA would result in normal phone around 150 extra standby hours.

This feature provides good power-saving capabilities in the current processor architecture.

### Scope of the Invention

Accordingly, the invention comprises the features of construction, combination of elements, and arrangement of parts which will be exemplified in the construction hereinafter set forth.

It will thus be seen that the objects set forth above, and those made apparent from the preceding description, are efficiently attained and, since certain changes may be made in the above construction without departing from the scope of the invention, it is intended that all matter contained in the above description or shown in the accompanying drawing shall be interpreted as illustrative and not in a limiting sense.

1. A method comprising:
receiving a chipset in a node, point, terminal or device that forms part of a wireless communications technology, including a wireless local area network (WLAN), or other suitable network, information about whether the host processor is in a sleep state; and
delaying forwarding one or more data packets from a WLAN chipset to a host processor based on information received by the WLAN chipset for power saving in node, point, terminal or device.

2. A method according to claim 1, wherein the host processor has a pin, such as a clock request pin, to indicate when it is in the sleep state.

3. A method according to claim 1, wherein the WLAN chipset has a pin that is connected to a sleep state signal of the host processor so that the WLAN chipset knows when it can wake up the host processor or not.

4. A method according to claim 1, wherein the WLAN chipset has an internal threshold timer to fulfil latency requirements for delivering packets to the host processor.

5. A method according to claim 1, wherein if the WLAN chipset detects via a wired connector that the host processor is in the sleep state, then the WLAN chipset will not deliver any packets to the host processor until one of the following conditions is met:
a) a receive (RX) delay timer has expired,
b) the WLAN chipset starts to run out of memory or a buffering threshold,
c) the host processor wakes up before the RX delay timer has been expired, or
d) a packet being delayed has been configured to be a high priority packet from a system point of view that would suffer from the extra latency.

6. A method according to claim 1, wherein the WLAN chipset provides a signal on an interrupt pin to wake up the host processor from the sleep state.

7. A method according to claim 6, wherein the WLAN chipset provides the signal after the WLAN chipset internal timer expires or after the host processor wakes up.

8. A method according to claim 7, wherein the host processor wakes up after a host processor internal time expires.

9. A method according to claim 1, wherein the node, point, terminal or device is a station (STA), or other suitable network node or terminal in the WLAN.

10. A node, point, terminal or device comprising:
a first chipset module configured for receiving information about whether a host processor is in a sleep state, where the node, point, terminal or device forms part of a wireless communications technology, including a wireless local area network or other suitable network; and
a second chipset module configured for delaying forwarding one or more data packets to the host processor based on the information received.

11. A node, point, terminal or device according to claim 10, wherein the host processor has a pin, such as a clock request pin, to indicate when it is in the sleep state.

12. A node, point, terminal or device according to claim 10, wherein the WLAN chipset has a pin that is connected to a sleep state signal of the host processor so that the WLAN chipset knows when it can wake up the host processor or not.

13. A node, point, terminal or device according to claim 10, wherein the WLAN chipset has an internal threshold timer to fulfil latency requirements for delivering packets to the host processor.

14. A node, point, terminal or device according to claim 10, wherein if the WLAN chipset detects via a wired connector that the host processor is in the sleep state, then the WLAN chipset will not deliver any packets to the host processor until one of the following conditions is met:
a) a receive (RX) delay timer has expired,
b) the WLAN chipset starts to run out of memory or a buffering threshold,
c) the host processor wakes up before the RX delay timer has been expired, or
d) a packet being delayed has been configured to be a high priority packet from a system point of view that would suffer from the extra latency.

15. A node, point, terminal or device according to claim 10, wherein the WLAN chipset provides a signal on an interrupt pin to wake up the host processor from the sleep state.

16. A node, point, terminal or device according to claim 15, wherein the WLAN chipset provides the signal after the WLAN chipset internal timer expires or after the host processor wakes up.

17. A node, point, terminal or device according to claim 16, wherein the host processor wakes up after a host processor internal time expires.

18. A node, point, terminal or device according to claim 10, wherein the node, point, terminal or device is a station (STA), or other suitable network node or terminal in the WLAN.

19. A chipset comprising:
a first chipset module configured for receiving information about whether a host processor is in a sleep state for a node, point, terminal or device that forms part of a wireless communications technology, including a wireless local area network or other suitable network; and
a second chipset module configured for delaying forwarding one or more data packets to the host processor based on information received.

20. A WLAN chipset according to claim 19, wherein the WLAN chipset has a pin that is connected to a corresponding pin, such as a clock request pin, of the host processor that indicate when it is in the sleep state so that the WLAN chipset knows when it can wake up the host processor or not.

21. A WLAN chipset according to claim 19, wherein the WLAN chipset has an internal threshold timer to fulfil latency requirements for delivering packets to the host processor.

22. A WLAN chipset according to claim 19, wherein if the WLAN chipset detects via a wired connector that the host processor is in the sleep state, then the WLAN chipset will not deliver any packets to the host processor until one of the following conditions is met:
a) a receive (RX) delay timer has expired,
b) the WLAN chipset starts to run out of memory or a buffering threshold,
c) the host processor wakes up before the RX delay timer has been expired, or
d) a packet being delayed has been configured to be a high priority packet from a system point of view that would suffer from the extra latency.

23. A WLAN chipset according to claim 19, wherein the WLAN chipset provides a signal on an interrupt pin to wake up the host processor from the sleep state.

24. A WLAN chipset according g to claim 23, wherein the WLAN chipset provides the signal after the WLAN chipset internal timer expires or after the host processor wakes up.

25. A WLAN chipset according to claim 24, wherein the host processor wakes up after a host processor internal time expires.

26. A WLAN chipset according to claim 19, wherein the network node, point, terminal or device includes a station (STA), or other suitable network node or terminal in the WLAN.

27. A computer program product with a program code, which program code is stored on a machine readable carrier, for carrying out the steps of a method comprising receiving in a chipset of a node, point, terminal or device that forms part of a wireless communications technology, including a wireless local area network or other suitable network, information about whether a host processor is in a sleep state, and delaying forwarding one or more data packets from the chipset to the host processor based on the information received, when the computer program is run in a module of either a node, point, terminal or device, such as a station (STA), an Access Point (AP), or other suitable node, point, terminal or device.

28. A method according to claim 1, wherein the method further comprises implementing the step of the method via a computer program running in a processor, controller or other suitable module in one or more network nodes, points, terminals or elements in the wireless LAN network.

29. A method comprising:
receiving one or more data packets from a wireless communications network, including a wireless local area network (WLAN) or other suitable network;
obtaining information regarding an operational state of a host processor; and
if the host processor is in a sleep state, delaying forwarding of the one or more data packets to the host processor until one or more threshold criteria is met for enhancing power savings in a wireless communications technology, including a wireless local area network (WLAN) or other suitable network.

30. A method according to claim 29, wherein packets are not delivered to the host processor until one or more of the following threshold criteria conditions is met:
a) a receive (RX) delay timer has expired,
b) a WLAN chipset starts to run out of memory or a buffering threshold, or
c) the host processor wakes up before the RX delay timer has been expired.

31. A method according to claim 1, wherein the host processor provides a system clock request signal to get a main processor running.

32. A method according to claim 31, wherein the host processor provides the system clock request signal to the WLAN chipset.

33. A node, point, terminal or device according to claim 10, wherein the host processor provides a system clock request signal to get a main processor running.

34. A node, point, terminal or device according to claim 10, wherein the host processor provides the system clock request signal to the WLAN chipset.

35. A WLAN chipset according to claim 19, wherein the WLAN chipset receives a system clock request signal from the host processor indicating that the host processor is trying to get the main processor running.

36. Apparatus comprising:
means for receiving in a chipset in a node, point, terminal or device that forms part of a wireless communications technology, including a wireless local area network (WLAN), or other suitable network, information about whether the host processor is in a sleep state; and
means for delaying forwarding one or more data packets from a WLAN chipset to a host processor based on information received by the WLAN chipset for power saving in node, point, terminal or device.
